(19) United States
(12) Patent Application Publication
(10) Pub. No.: US 2024/0211931 A1
(43) Pub. Date: Jun. 27, 2024

(54) METHOD AND SYSTEM FOR APPROVING USE OF MOBILE WALLET

(71) Applicant: Wells Fargo Bank, N.A., San Francisco, CA (US)

(72) Inventor: Joon Maeng, Newcastle, WA (US)

(21) Appl. No.: 15/401,664

(22) Filed: Jan. 9, 2017

(51) Int. Cl. G06Q 20/36; G06Q 20/40

(52) U.S. Cl. CPC G06Q 20/367; G06Q 20/40

(57) ABSTRACT

A payment processing system is provided. The payment processor includes one or more processors coupled to non-transitory memory, wherein the non-transitory memory stores instructions executable by the one or more processors and cause the one or more processors to receive a message, the message requesting payment from a mobile wallet account of a mobile wallet user. The instructions also cause the processor to initiate, based on the message, communications between the mobile wallet user and an approver associated with the mobile wallet account, the approver having authority to approve the payment, receive approval from the approver to complete the payment, and authorize, based on the approval, use of the mobile wallet account to complete the payment.

### TECHNICAL FIELD

The present disclosure relates generally to the field of mobile wallets. More specifically, the present invention relates to systems and methods for enabling a user of a mobile device to request authorization for use of an associated mobile wallet account to complete a transaction.

### BACKGROUND

Payments for products and services are often completed using credit cards, debit cards, checks, or cash. Generally, when completing a card transaction (e.g., debit card, credit card, gift card, etc.) at a brick-and-mortar merchant location, a person first locates their wallet, identifies which card from a plurality of cards to use for the purchase, swipes the card at a point of sale (“POS”) terminal, and signs for the transaction. At the same time, most people carry some type of mobile handheld electronic device, such as a cellular phone, smart phone, mobile handheld wireless e-mail device, personal digital assistant, portable gaming devices, and so on. Many of these devices have a wireless Internet connection.

A person may wish to make payments to merchants using these mobile devices. In some instances, a person may wish to make such payments from an account where the person is not the account holder but instead has some form of restricted access to the account. Examples include minor children with access to parents' accounts and employees with access to employers' accounts. Persons seeking to make such payments may desire to do so without the actual holder of the account being present at the time of the transaction. Accordingly, enhanced systems and methods of facilitating such transactions using mobile devices would be desirable.

### SUMMARY

One embodiment relates to a payment processing system. The payment processing system includes one or more processors coupled to non-transitory memory, wherein the non-transitory memory stores instructions executable by the one or more processors and cause the one or more processors to receive a message, the message requesting payment from a mobile wallet account of a mobile wallet user. The instructions also cause the processor to initiate, based on the message, communications between the mobile wallet user and an approver associated with the mobile wallet account, the approver having authority to approve the payment. The instructions also cause the processor to receive approval from the approver to complete the payment. The instructions also cause the processor to authorize based on the approval, use of the mobile wallet account to complete the payment.

Another embodiment relates to a computer-implemented method. The method includes receiving, by a processor of a payment processing system, a message, the message requesting payment from a mobile wallet account of a mobile wallet user. The method also includes initiating, by the processor, based on the message, communications between the mobile wallet user and an approver associated with the mobile wallet account, the approver having authority to approve the payment. The method also includes receiving, by the processor, an approval from the approver to complete the payment. The method also includes authorizing, by the processor, based on the approval, use of the mobile wallet account to complete the payment.

Another embodiment relates to a computer-implemented method. The method includes receiving, by a processor of a payment processing system, a message, the message requesting payment from a mobile wallet account of a mobile wallet user. The method also includes determining, by the processor, based on a rules engine stored in a memory of the payment processor computing system, that the message requires approval from an approver associated with the mobile wallet account, the approver having authority to approve the payment. The method also includes initiating, by the processor, responsive to determining that the message requires approval, communications between the mobile wallet user and the approver. The method also includes receiving, by the processor, an approval from the approver to complete the payment. The method also includes authorizing, by the processor, based on the approval, use of the mobile wallet account to complete the payment.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a schematic diagram of a computer-implemented payment processing system for facilitating mobile wallet payments according to an example embodiment.

FIG. 2 is a block diagram of a mobile wallet provider system operating in the computer environment of FIG. 1.

FIG. 3 is a process for approving a mobile wallet transaction using the system of FIG. 1, according to an example embodiment.

FIG. 4 is a process for approving a mobile wallet transaction, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

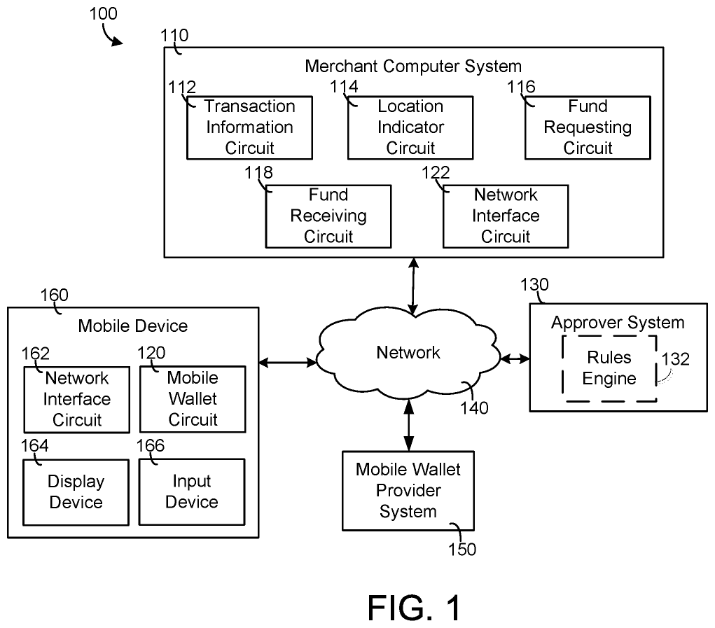

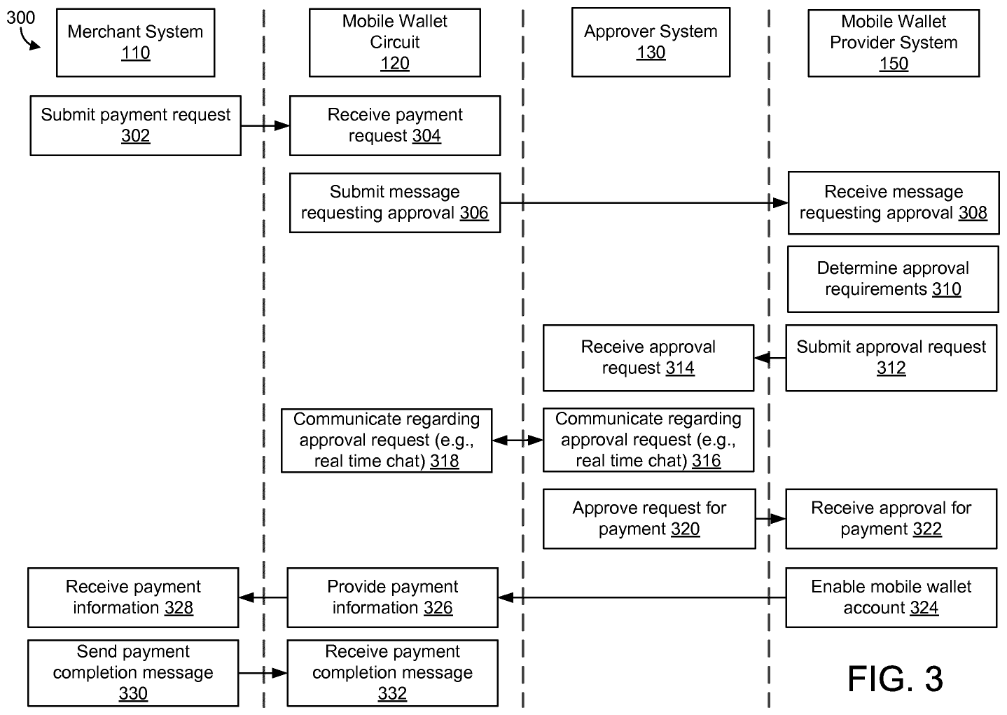

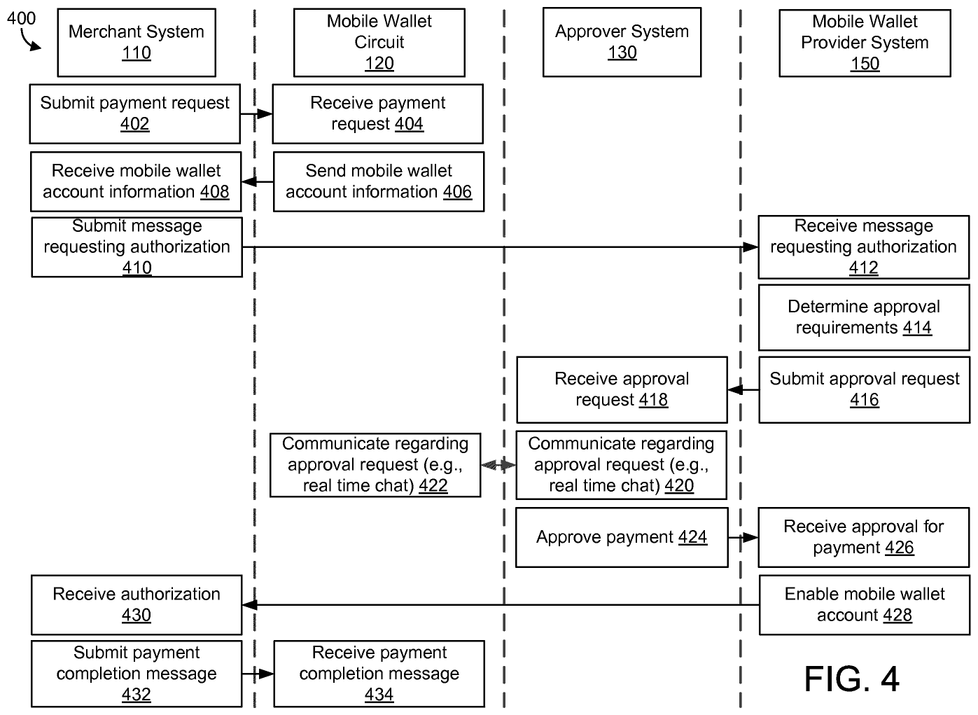

Referring to FIG. 1, a diagram of a payment processing system 100 is shown, according to an example embodiment. Payment processing system 100 may facilitate payment from a customer to a merchant via a mobile wallet provided by a mobile wallet provider system 150. Payment processing system 100 may include, among other systems, a merchant computer system 110, a mobile device 160, an approver system 130 (e.g., an account holder approval application hosted on a mobile device), and the provider system 150. In an example embodiment, the systems are each operated by a separate entity. In some embodiments, two or more systems may be combined to operate as a single system, and/or owned or operated by a single entity. Merchant computer system 110, mobile device 160, approver system 130, and provider system 150 may each comprise a computer system (e.g., one or more servers each with one or more processors) configured to execute instructions, send and receive data stored in memory, and perform other operations to implement the operations described herein and/or associated with logic or processes shown in FIGS. 3-4.

Merchant computer system 110 is a computing system associated with a merchant. The merchant may include any entity capable of providing goods or services to a customer in exchange for payment. Examples of merchants include retailers, wholesalers, marketplace operators, service providers (e.g., loan servicers, cleaning services, transportation providers, etc.), non-product or non-service based entities (e.g., governmental or regulatory entities) and so on. The merchant may be an online merchant or a merchant having a physical (i.e., brick-and-mortar) store.

Merchant computer system 110 may be used at a point of sale location to conduct transactions with the mobile wallet user. For example, the merchant computer system 110 may include a point of sale computer system such as a cash register system connected to a central server system operated by the merchant. In other embodiments, the merchant computer system 110 may include a mobile computing device (e.g., smartphone, tablet PC, etc.) operated by a store clerk as the clerk moves throughout the store. The mobile computing device operated by the clerk in such an embodiment may connect to a central server system operated by the merchant.

Merchant computer system 110 may include various circuits, including transaction information circuit 112, location indicator circuit 114, fund requesting circuit 116, fund receiving circuit 118, and network interface circuit 122. Transaction information circuit 112 is configured to transmit information regarding a transaction, such as the cost of each product (e.g., good or service) involved in the transaction, a description of each product involved in the transaction, the total number of products involved in the transaction, etc. Location indicator circuit 114 is configured to transmit location information, such as the geographic location of the physical store involved in the transaction, or the internet address of the online merchant involved in the transaction. Fund requesting circuit 116 is configured to transmit a request to mobile device 160 or provider system 150 to complete a payment transaction. Fund receiving circuit 118 may be configured to accept a transfer of funds from a source financial institution (e.g., via mobile wallet circuit 120 or provider system 150) to complete a payment transaction. In some embodiments, fund receiving circuit 118 is at least partially operated by an acquiring financial institution providing a financial account to the merchant. Fund receiving circuit 118 may also notify the user of the mobile device 160 that the payment transaction has been completed and generate a receipt based on the transaction completion. Network interface circuit 122 is configured to utilize network 140 to transmit and receive messages with the other systems and components of the payment processing system 100.

Merchant computer system 110 may include or be integrated with other hardware. For example, in one embodiment, the merchant computer system 110 includes a card reader for reading credit cards, debit cards, stored value cards, and so on. As another example, the merchant computer system 110 may be configured to prompt the mobile wallet user to provide a random security code. The random security code may be provided to the merchant computer system 110 directly by mobile device 160, may be keyed into the merchant computer system 110 (e.g., by a store clerk), or may be received in another manner.

Still referring to FIG. 1, mobile device 160 may be utilized to access a mobile wallet account of a mobile wallet user, including to make a payment from a source account using mobile device 160. The mobile wallet user may be a business entity and/or an individual customer. Mobile device 160 may be, for example, a cellular phone, smart phone, wireless email device, personal digital assistant, portable gaming device, or any other suitable device. Mobile device 160 includes mobile wallet circuit 120, network interface circuit 162, display device 164, and input device 166.

Mobile wallet circuit 120 may be used to access a mobile wallet account. The mobile wallet account may be established in a variety of ways. For example, the mobile wallet account may be established through an online interface of provided by a mobile wallet provider, such as the provider that operates provider system 150. The online interface may include an online banking area of a website of a banking institution. In some embodiments, the mobile wallet user may download a mobile wallet application offered by the mobile wallet provider and follow prompts within the mobile application to establish a mobile wallet account. In other embodiments, the mobile wallet account may be established by telephoning provider system 150 and speaking with a representative or following automated account creation prompts. In some embodiments, the mobile wallet user may access the mobile wallet account using a computer system other than mobile device 160 (e.g. a desktop or laptop computer executing browser software), including to perform the operations described herein as being performed by mobile device 160.

Mobile wallet circuit 120 may comprise program logic (e.g., a client application) executable by mobile device 160 to implement at least some of the functions described herein. For example, mobile device 160 may receive and display screens including source account information, approver information, transaction instructions, and so on. In an example embodiment, such screens may be used to request a username and password information associated with the mobile wallet account. Such screens may also be used to prompt the user to provide information regarding the amount of the payment and which merchant or individual is to receive the payment. Such screens may be presented to the user via display device 164. Input device 166 may be used to permit the user to initiate account access and to facilitate receiving requested information from the user.

Mobile wallet circuit 120 may be at least partially provided and/or operated by provider system 150. As will be appreciated, the level of mobile wallet functionality that resides on mobile device 160 as opposed to provider system 150 may vary depending on the implementation. In some embodiments, mobile wallet circuit 120 may include a web browser that is configured to receive and display web pages from provider system 150 (e.g., web pages prompting the user to provide information to create a mobile wallet account, web pages displaying source account balance information, web pages displaying a record of past transactions, and so on).

In some embodiments, the mobile wallet account may be one of a plurality of mobile wallet accounts funded by the same source account. Each of the plurality of mobile wallet accounts may be provided by provider system 150. The plurality of mobile wallet accounts may be utilized by mobile wallet users by requesting approval from an approver (e.g., the source account holder) to complete a payment transaction using funds from the source account. For example, multiple employees may have access to one or more associated mobile wallet accounts that require approval from an employer (e.g., a source account holder) to perform a transaction. In another example, multiple children may have separate mobile wallet accounts that require approval from a parent or guardian (e.g., a source account holder) to access a shared source account. In an alternative embodiment, a single mobile wallet user may utilize a plurality of mobile wallet accounts, with each account receiving funds from a different source account with an associated approver.

Still referring to FIG. 1, approver system 130 may be used to approve a request for a payment transaction. Approver system 130 may include a mobile device or other computing device that is operated by an approver. The approver is a user with authority to authorize or deny a request to complete a mobile wallet transaction. Although mobile wallet circuit 120 or merchant system 110 may be utilized to request funds from a source account to initiate a mobile wallet transaction, authorization via approver system 130 may be required in order to transmit the funds from the source account.

Approver system 130 may be associated with a source account accessible by mobile wallet circuit 120. The source account may be a business or consumer demand deposit, credit card, debit card account, line of credit, etc. In some embodiments, the approver may be the account holder of the source account (e.g., a parent may be the account holder of a checking account that serves as the source account for a child's mobile wallet account). In some embodiments, the approver may have authority by virtue of their status (e.g., a manager, an executive officer, etc.) to authorize or deny requests to complete a payment using funds from a source account (e.g., an employer may be able to authorize or deny requests from an employee mobile wallet account for requests for payment from a business line of credit).

In some embodiments, the approver may have an approver account (e.g., provided by provider system 150). The approver account is accessible using the approver system 130, which may include a mobile device or other computing device used by the approver. In an example embodiment, the approver account may be accessed from a client application on the approver's mobile device similar that discussed above in relation to the mobile wallet circuit 120. The mobile device may be, for example, a cellular phone, smart phone, wireless email device, personal digital assistant, portable gaming device, or any other suitable device. The approver mobile device may be similar to mobile device 160, and any description herein relating to mobile device 160 may apply similarly to the approver mobile device, including any associated functions or components. In an example embodiment, the approver mobile device is configured to receive and display screens used to request a username and password information associated with the approver account, or otherwise required to approve a mobile wallet transaction. Such screens may also be used to prompt the approver to indicate the authorization or denial of a request to complete a payment transaction. Such screens may be provided by a mobile application provided by provider system 150.

Alternatively, the approver system 130 may include a web browser that is configured to receive and display mobile web pages received from provider system 150 (e.g., web pages prompting the approver to create an account, web pages displaying source account balance information and past transactions from all mobile wallet accounts associated with the source account, web pages prompting the approver to authorize or deny a payment transaction, etc.). In some embodiments, the approver may utilize a website or web application accessed using another type of computer (e.g. a desktop or laptop computer executing browser software) to indicate authorization or denial in response to a request to complete a mobile wallet transaction.

Alternatively, provider system 150 may include a designation of an approver for a mobile wallet account, rather than the creation of a full approver account. In these embodiments, the approver may provide contact information, such as a telephone number or email address, to provider system 150. Provider system 150 may contact the approver via text message, telephone call, or email (e.g., at the approver system 130) when a request for authorization to complete a mobile wallet transaction is received. The approver may then indicate an authorization or denial of the request (e.g., by approver system 130) via a text message, verbal, or email response to provider system 150, or by accessing an online interface provided by provider system 150.

In various embodiments, approver system 130 may include a plurality of approver accounts associated with a single mobile wallet account. For example, both a mother and a father may have an approver account that a child mobile wallet user may request authorization from in order to transmit funds from the parents' joint checking account. In some embodiments, a plurality of approver accounts may mean that, in the event that an approver is unavailable to provide authorization when a request to transmit funds is received, an alternate approver may receive the request and grant authorization in order to facilitate an efficient completion of the payment transaction. In other embodiments, authorization from multiple approvers may be required before funds are transmitted to the mobile wallet account.

The approver (e.g., using approver system 130) may configure the approval settings for an associated mobile wallet account. In some embodiments, the settings may be configured such that every payment transaction involving the mobile wallet account requires approval before the transaction can be completed. In some embodiments, the settings may be configured such that payment transactions above a certain dollar amount require approval before the transaction can be completed. For example, approval from an employer approver may be required for an employee mobile wallet user to complete a purchase above a specified dollar amount (e.g., for manufacturing equipment), but not required for the employee mobile wallet user to complete a purchase below the specified dollar amount (e.g., for pens or other office supplies). Alternatively, approval may be required based on whether the transaction originates from a designated merchant or category of merchant, or if the transaction includes the purchase of a designated good or service, or a designated category of good or service. For example, approval from a parent may be required for a child mobile wallet user to complete a transaction at a liquor store or a transaction including the purchase of a video game with explicit content. In another example, approval from an employer may be required for an employee mobile wallet user to complete a transaction with an office supply company that does not have a pre-existing relationship with the employer. The approver may receive notice of such information related to the mobile wallet transaction from the merchant computer system 110.

In some embodiments, the approver may provide mobile wallet account settings to the provider system 150 that configure the provider system to automatically deny various authorization requests. For example, a particular approver may set account settings such that certain items cannot be purchased using the source account accessible by the mobile wallet circuit 120 (e.g., alcohol). In some embodiments, the account settings may be stored at the mobile wallet provider system 150 (e.g., in the rules engine 210 described below) such that the mobile wallet provider system 150 automatically rejects any authorization requests for a transaction involving a prohibited item. This way, the approver system 130 reduces the number of authorization requests received. Alternatively the mobile wallet account settings may be stored at the approver system 130 (e.g., in a mobile wallet application implementing a mobile wallet). For example, the mobile wallet account settings may be included in a rules engine 132 of the approver system 130. In various arrangements, the rules engine 132 may be similar in structure and function to the rules engine 210 of the mobile wallet provider system 150 discussed below. The rules engine 132 may be configured to assess characteristics of a message received from the mobile wallet provider system 150 to determine the compatibility of the received message with the account settings set by the approver. For example, the rules engine 132 may be configured to determine if a payment amount included in the received message exceeds a predetermined threshold and, if so, automatically transmit a denial responsive to receiving the message. In some embodiments, different account settings may be stored simultaneously at both the approver system 130 and the mobile wallet provider system 150.

Still referring to FIG. 1, network 140 facilitates communication between any or all of merchant system 110, mobile device 160, approver system 130, and provider system 150. Network 140 may include private networks, public networks, or a combination thereof. In some arrangements, network 140 includes the Internet. In other arrangements, network 140 includes mobile telephone networks, plain old telephone service (POTS) networks, local area networks, Near Field Communication (NFC), or any other type of wired or wireless network.

Provider system 150 is operated by an entity that provides administration of the mobile wallet service (i.e., a mobile wallet provider). In various embodiments, provider system 150 may be a financial institution, a software company, a mobile telephone company, a consortium, or any other organization that provides the mobile wallet functionality (e.g., the mobile wallet account, mobile wallet application, etc.) to the mobile wallet user and the approval mechanism to the approver. In some embodiments, provider system 150 may be operated by a banking entity associated with the source account that provides funds to the mobile wallet. In other embodiments, the source account may be associated with (e.g., provided by) a different banking entity, and provider system 150 may instead provide administration of the mobile wallet and approver systems, and facilitate communications between them.

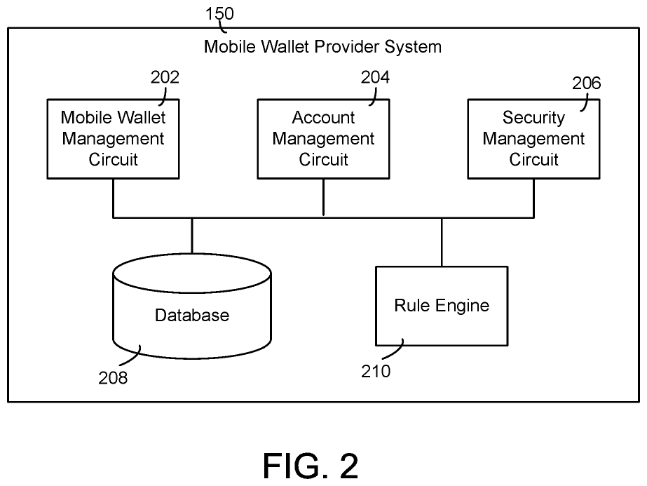

Referring now to FIG. 2, a block diagram of mobile wallet provider system 150 is shown, according to an exemplary embodiment. Provider system 150 may facilitate the process of obtaining approval for a mobile wallet transaction between merchant system 110, mobile device 160 (e.g., mobile circuit 120), and approver system 130. In this embodiment, provider system 150 includes mobile wallet management circuit 202, account management circuit 204, security management circuit 206, database 208, and rule engine 210, each of which may be communicably coupled.

Mobile wallet management circuit 202 is configured to manage interactions relating to use of the mobile wallet, including requests to authorize the transfer of funds, notification of authorization or denial of the request to transfer funds, and notification of the completion of the transfer of funds. Mobile wallet management circuit 202 may communicate with rule engine 210, including to determine the characteristics of the interactions (e.g., type, frequency, etc.) between mobile wallet circuit 120 and provider system 150. For example, mobile wallet management circuit 202 may communicate with rule engine 210 to determine whether authorization from an approver is required before sending a request for authorization or transmitting funds to complete a mobile wallet transaction. The determination may be made based on approval rules stored in rule engine 210, which may be provided by an approver and/or a mobile wallet user.

Account management circuit 204 is configured to manage the mobile wallet account, which may include the designation of an approver and/or an approver account, and any associations therebetween. During the registration process for the mobile wallet account, the user may be prompted to provide a source account to serve as a source of funds for the mobile wallet account. Before the source account can be associated with the mobile wallet account, account management circuit 204 may query the financial institution associated with the source account, the source account holder, etc. in order to gain approval to make the association. While querying the financial institution and/or the source account holder, account management circuit 204 may associate an approver and/or an approver account with the mobile wallet account. The approver may be designated by the source account holder. Account management circuit 204 may further manage the designated approver(s) in embodiments in which a plurality of mobile wallet accounts and/or approver(s) are associated with a single source account.

Security management circuit 206 may be configured to perform functions that ensure that all transactions performed using mobile wallet circuit 120, including any communications with approver system 130 and provider system 150, are secure. For example, security management circuit 206 may verify the identity of the mobile wallet user by requiring the user to input a username and password before the user may use the mobile wallet account. The mobile wallet user may be required to authenticate prior to initiating a request to the approver (e.g., through provider system 150) to authorize a payment transaction. In one embodiment, the mobile wallet user may be required to enter a personal identification number (PIN) before a request can be generated. Security management circuit 206 may require similar measures (i.e., input of a username and password, input of a PIN) to verify the identity of the approver prior to provider system 150 transmitting a payment request to approver system 130, or prior to provider system 150 receiving an authorization or a denial of a payment request from approver system 130.

In some embodiments, security management circuit 206 may encrypt and decrypt information transmitted between any of mobile wallet circuit 120, approver system 130, and provider system 150. Encryption and decryption of the information transmitted may involve security management circuit 206 performing various tokenization functions associated with the processed transactions. The tokenization functions include the ability to create tokens that identify customer accounts involved in the transactions. Each token may be a string of characters (e.g., numbers, letters, symbols) that represents an encoded version of a customer account number associated with a given transaction. The account number can be retrieved by decoding the token. The use of tokens instead of actual customer account numbers provides an added layer of data theft protection, thereby further protecting the integrity of customer accounts. In some embodiments, token services are provided by a third-party token service provider.

Database 208 may be configured to store all information relating to the mobile wallet accounts, including any information required by mobile wallet management circuit 202, account management circuit 204, security management circuit 206, and rule engine 210. This information may include, but is not limited to, mobile wallet account information, approver account information, and source account information. For example, mobile wallet account information and approver account information may include user authentication information (e.g., username/password combinations, device authentication tokens, security question answers, etc.). Source account information may include account balance information, transaction history, etc. Database 208 may further include statistical and analytical information regarding the usage of the payment processing system 100. For example, statistical information may include average transaction amount, most common transaction origin, average time for approver to authorize transaction, etc.

Rule engine 210 may be configured to generate rules regarding the approval required to use a mobile wallet account (e.g., transfer funds from a source account) to complete a transaction. To generate rules, rule engine 210 may utilize information stored in database 208. The rule engine 210 may also utilize mobile wallet management circuit 202, account management circuit 204, and security management circuit 206. The rules may be generated based on input received from a user (e.g., an approver, a mobile wallet user, the source financial institution, etc.) of the payment processing system 100. The rules may include whether an approval is required, the type of approval required, how the request for approval is initiated, and how approval is transmitted. For example, a rule generated by rule engine 210 may require that transactions in excess of a particular dollar amount require approval by an approver. As another example, a rule may require that approval be granted via text message. Rules may also be generated related to account priority in embodiments where multiple mobile wallet accounts or approvers (e.g., approver accounts) are associated with the same source account. For example, rule engine 210 may generate a rule designating the amount of time that provider system 150 waits for an approver to respond to a request to authorize a payment transaction before provider system 150 sends a request to a secondary approver to authorize the transaction.

Referring now to FIG. 3, a process 300 is shown for facilitating approval of a mobile wallet transaction, according to an example embodiment. The process 300 is performed using payment processing system 100 shown in FIG. 1. In particular, the process 300 may be performed using one or more of merchant computer system 110, mobile device 160, approver system 130, and provider system 150 shown in FIG. 1, including any stored applications (e.g., mobile applications specific to the provider system or the merchant), circuits or other components of the systems and devices that are described in further detail herein.

At block 302 of the process 300, merchant computer system 110 transmits a payment request that is received by mobile wallet circuit 120 (e.g., mobile device 160) at block 304. The payment request is generated based on a mobile wallet transaction initiated by the mobile wallet user. For example, the payment request may be generated based on a request by the mobile wallet user to purchase various goods or services from the merchant. The payment request may include an invoice for payment of such goods or services, including a description and cost associated with the goods or services. In some embodiments, the payment request is transmitted by an interaction between mobile device 160 and a cash register or other point of sale device of the merchant in a physical (i.e., brick-and-mortar) store. For example, the message may be generated and/or sent by merchant computer system 110 in response to the mobile wallet user presenting mobile device 160 at the point of sale device, initiating a communication event between mobile device 160 and the point of sale device. In other embodiments, the message is transmitted electronically (e.g., remotely via network 140) when the mobile wallet user initiates a purchase from an online merchant. In these embodiments, the message may be generated and sent in response to the mobile wallet user inputting mobile wallet account information when prompted to complete payment.

At block 306, mobile wallet circuit 120 transmits a message to provider system 150, requesting approval of the mobile wallet transaction (e.g., to authorize the transmission of funds to complete the mobile wallet payment). The message is received by provider system 150 at block 308. The message may be sent by mobile device 160. In some embodiments, the message includes information about the transaction, which may include the amount of the transaction, the goods and/or services to be purchased in the transaction, the name and geographic location of the merchant involved in the transaction, and any other information that may be required to approve the transaction or determine any approval requirements.

In some embodiments, mobile wallet circuit 120 (e.g., mobile device 160) determines that approval is required for the transaction prior to sending the message to provider system 150. The determination may be made based on settings associated with the mobile wallet account. For example, the account holder (e.g., the approver) may customize the account settings to require approval of all mobile wallet transactions using the mobile wallet account or by the mobile wallet user. The determination may also be made based on details relating to the transaction. For example, mobile wallet circuit 120 may determine that approval is required by comparing transaction details to any rules associated with the account. If approval is not required, mobile wallet circuit 120 may provide payment information (e.g., a payment token) to merchant system 110 to proceed with the mobile wallet transaction. Alternatively, if the account settings identify an item that cannot be purchased using the source account associated with the mobile wallet circuit 120 and the message requesting approval includes such an item, the mobile wallet circuit 120 may be sent a denial by the provider system 150.

At block 310, provider system 150 determines the approval requirements for the requested transaction. The requirements may be based on the mobile wallet account. The requirements may also be based on the details of the transaction. In some embodiments, provider system 150 determines the approval requirements by comparing the details of the transaction to rules associated with the mobile wallet account (e.g., rules stored in rule engine 210). For example, a rule may require approval from an approver if a transaction exceeds a certain dollar amount (e.g., approval from a parent may be required if a child mobile wallet account attempts to complete a payment transaction in excess of $40), includes specified goods or services or a category of goods or services, or involves a specified or type of merchant.

At block 312 provider system 150 transmits an approval request for the mobile wallet transaction, which is received by approver system 130 at block 314. The approval request may be similar to the message received from mobile wallet circuit 120 (e.g., mobile device 160) at block 306. In some embodiments, provider system 150 sends the approval request to the approver electronically, via such methods as email, text message, etc. In some embodiments, the approver may receive the approval request via a notification (e.g., a push notification) generated by a mobile application operating on the approver's mobile device (i.e., approver system 130). Alternatively, provider system 150 may contact the approver via phone call. In some embodiments, provider system 150 may utilize information stored in database 208 and rules generated by rule engine 210 to determine characteristics of the transmission (e.g., method of transmission) and/or whether to transmit the approval request. For example, provider system 150 may assess the likelihood that the transaction is fraudulent (e.g., based on the transaction information, user-provided settings, etc.), and if a high likelihood of fraud is determined, provider system 150 may decline to transmit the approval request to the approver.

Still referring to FIG. 3, at blocks 316 and 318 approver system 130 (e.g., the approver) and mobile wallet circuit 120 (e.g., mobile device 160, the mobile wallet user) exchange one or more messages regarding the request for approval received in block 314. In various embodiments, this communication may occur in real time within a chat feature of a mobile application which may be facilitated by the mobile wallet provider (e.g., a mobile wallet application implemented by the mobile wallet provider system 150), via text message, or via telephone call. In one embodiment, the communication is initiated prior to the approver system receiving the approval request at 314. For example, the mobile wallet provider system 150 may receive the message requesting approval, determine that approval is required from the approver (e.g., via the rules engine 210), and initiate communications between the approver system 130 and the mobile device 160. Initiating communications between the mobile device 160 and the approval device may include transmitting a communication prompt to the approver system 130. The communication prompt may take the form of a push notification, and be viewable by the approver on a mobile wallet client application implemented on the approver system 130.

In some embodiments, communication is initiated responsive to the approver system 130 determining that an automated response cannot be given to the approval request received at 314. As discussed above, the approver system 130 may include a rules engine 132 that configures the approver system to automatically respond (e.g., transmit an approval or denial notification to the mobile wallet provider system 150) to the approval request when the approval request has certain characteristics (e.g., being above or below monetary thresholds, the payment request involving a particular item or merchant, etc.). In some embodiments, when the approval request received at 314 does not have characteristics that generate an automated response from the approver system 130, the approver system 130 initiates real time communications between the approver and the mobile wallet user.

During the communication between the mobile wallet user and the approver, the approver may question the mobile wallet user regarding the details of the transaction. For example, a communication prompt transmitted by the mobile wallet provider system 150 to the approver system 130 may enable the approver to ask the mobile wallet user to provide justification for the purchase or to suggest an alternative purchase. In some embodiments, any inputs into the communication prompt entered by the approver may be communicated to the mobile wallet provider system 150, and relayed to the mobile device 160 in the form of another communication prompt. Any responses from the mobile wallet user may be transmitted by an application (e.g., the mobile wallet circuit 120) on the mobile device 160 to the mobile wallet provider system 150, which may in turn transmit a request for approval to the approver system 130. In some embodiments, this communication may be optional, as the approver may choose to authorize or deny the transaction without further input from the mobile wallet user. In some embodiments, provider system 150 facilitates communication between approver system 130 and mobile wallet circuit 120 (e.g., mobile device 160). In one embodiment, the approver system may examine the approval request based on the rules stored in the approver system and rejects it if the request does not meet the rules or approves it if the request meet the rules without presenting it to the user of approver system. In other words, the approver systems 130 determines an approval or a rejection without communicating with the mobile wallet 120.

At block 320, the approver (e.g., approver system 130) approves the request by sending a message to provider system 150. Provider system 150 receives this approval in block 322. In various embodiments, the approver may send the approval via electronic means using approver system 130. For example, the approver may click on an authorization button in a mobile application, or send an approval phrase or code to provider system 150 via text message. In some embodiments, the approver may verbally provide approval via telephone call to provider system 150.

At block 324, provider system 150 facilitates the transaction based on the approval received from the approver (e.g., approver system 130). Provider system 150 facilitates the transaction by enabling use of the mobile wallet account, allowing mobile wallet circuit 120 to provide payment information to merchant system 110. In some embodiments, provider system 150 may be a banking entity associated with the source account that funds the mobile wallet. In these embodiments, the provider system 150 may send funds from the source account to the merchant computer system 110 upon receiving approval from approver system 130, completing the transaction.

At block 326, the mobile wallet circuit 120 provides payment information to merchant computer system 110. For example, the payment information may include a payment token representing a source payment account of the mobile wallet user and/or the approver. The payment information is received by merchant system 110 at block 328. For example, mobile wallet circuit 120 (e.g., a mobile wallet application operating on mobile device 160) may provide a code or barcode that may be entered into or scanned by the merchant's point of sale equipment. In some embodiments, merchant system 110 receives the payment information by a contactless communication (e.g., near field communication) between mobile device 160 and merchant system 110. In other embodiments, the mobile wallet user may not be required to provide any further information or take any additional steps after the payment has been approved to complete the transaction. For example, merchant system 110 may receive a payment token when the mobile wallet transaction is initiated, which may be activated or enabled by provider system 150 upon approval of the transaction by the approver.

At blocks 330 and 332, merchant system 110 transmits a message that is received by mobile wallet circuit 120 (e.g., mobile device 160), indicating that the transaction has been completed. The message may be sent after the funds have been transferred to a merchant account from a source payment account associated with the mobile wallet. In some embodiments, merchant computer system 110 may send a receipt electronically directly to mobile wallet circuit 120. In some embodiments, provider system 150 sends a receipt to the user via mobile wallet circuit 120. Such a receipt may be stored in a receipt history in the mobile wallet application of the user's mobile device 160. Past receipts from the receipts history may be retrieved and displayed to the mobile wallet user using mobile wallet circuit 120. The mobile wallet user may also, using mobile wallet circuit 120, search the receipts for transactions relating to specific products, specific merchants, or specific locations of transactions. In various embodiments, the electronic receipt may also be sent to the approver. For example, the electronic receipt may be sent to an application installed on the approver's mobile device, and the approver may view the receipt history in the same manner as the mobile wallet user. If multiple mobile wallet accounts are associated with the same source account, the approver may review the receipt history of transactions from all associated mobile wallet accounts.

The receipt of the payment transaction may be transmitted to the mobile wallet user using various other means. For example, merchant computer system 110 may provide the mobile wallet user with a paper receipt as evidence of the completed transaction. In some embodiments, receipts may be emailed in electronic format to the email address(es) of the mobile wallet user and/or the approver. In some embodiments, the mobile wallet user and/or the approver may receive a notification of the transaction completion through various other methods, including a notification within the mobile wallet application, a text message, or a phone call.

Referring now to FIG. 4, a process 400 is shown for facilitating approval of a mobile wallet transaction, according to an example embodiment. In this embodiment, approval is initiated by the merchant on behalf of the mobile wallet user. Process 400 is performed using the payment processing system 100 shown in FIG. 1. In particular, process 400 may be performed using one or more of merchant computer system 110, mobile device 160, approver system 130, and provider system 150 shown in FIG. 1, including any stored applications (e.g., mobile applications specific to the provider system or the merchant), circuits or other components of the systems and devices that are described in further detail herein.

Process 400 begins with block 402. Block 402 includes transmitting message payment request from merchant system 110 that is received by mobile wallet circuit 120 (e.g., mobile device 160) at block 404. The payment request may include an invoice or request for payment of goods or services. The payment request may be provided to the mobile wallet circuit 120 in response to a selection of goods or services for purchase by the mobile wallet user. In some embodiments, the transmission of the payment request may include a store clerk operating a cash register or other point of sale device in a physical (i.e., brick-and-mortar) store. For example, the payment request may be transmitted by a communication event between merchant system 110 and mobile device 160. In other embodiments, the message may be transmitted electronically when the mobile wallet user initiates a purchase from an online merchant.

Process 400 continues with block 406. Block 406 includes submitting information regarding the mobile wallet account from mobile wallet circuit 120 to merchant system 110, where it is received at block 408. In some embodiments, the user may present mobile device 160 to a store clerk and the clerk may input information regarding the mobile wallet account into merchant computer system 110. For example, the mobile wallet application may display a code or barcode that may be entered into or scanned by the point of sale device. In other embodiments, mobile device 160 transmits the mobile wallet account information to merchant system 110 by NFC, Bluetooth, or another contactless communication event. In other embodiments, the mobile wallet user may input mobile wallet account information into a website when prompted to complete payment by an online merchant. The mobile wallet account information may include a payment credential (e.g., account number, payment token, device identifier, user identifier, wallet identifier, etc.) identifying the mobile wallet account to merchant system 110. The mobile wallet account information may indicate to merchant system 110 whether the mobile wallet user has the authority to make a payment using the mobile wallet account.

Process 400 continues with merchant system 110 submitting a message requesting authorization (e.g., approval, payment, etc.) in block 410. The message is received by provider system 150 in block 412. In some embodiments, the message may include information about the transaction, including, but not limited to, the amount of the transaction, the goods and/or services to be purchased in the transaction, the name and geographic location of the merchant involved in the transaction, etc. Block 410 may further include merchant system 110 transmitting information regarding the mobile wallet account (e.g., mobile wallet account number, name of mobile wallet user, etc.) to provider system 150. In some embodiments, the message includes a payment credential associated with the mobile wallet account. The payment credential may be used by provider system 150 to identify the mobile wallet account.

At block 414, provider system 150 determines the approval requirements for the requested transaction. The approval requirements may be based on the identified mobile wallet account. The approval requirements may also be based on the details of the transaction. For example, provider system 150 may determine the approval requirements by comparing the details of the transaction to rules associated with the mobile wallet account (e.g., rules stored in rule engine 210). In various embodiments, a rule may require approval from an approver if a transaction exceeds a certain dollar amount (e.g., approval from a parent may be required if a child mobile wallet account attempts to complete a payment transaction in excess of $40).

At block 416, provider system 150 transmits an approval request to the determined approver (e.g., approver system 130). The approval request may include information received from merchant system 110. In various embodiments, provider system 150 may contact the approver electronically, via such methods as email, text message, etc. In some embodiments, the approver may receive an approval request via a notification generated by an application stored on the approver's mobile device (i.e., approver system 130). Alternatively, provider system 150 may transmit the approval request via phone call. In some embodiments, provider system 150 may utilize information stored in database 208 and rules generated by rule engine 210 to determine characteristics of the transmission (e.g., method of transmission) and/or whether to transmit the approval request at all. For example, provider system 150 may assess the likelihood that the transaction is fraudulent, and if a high likelihood of fraud is determined, provider system 150 may decline to transmit the approval request to the approver. The approval request is received by approver system 130 at block 418.

Still referring to FIG. 4, process 400 continues with blocks 420 and 422, which includes approver system 130 and mobile wallet circuit 120 (e.g., mobile device 160) communicating with each other regarding the approval request. In various embodiments, this communication may occur within a chat feature of a mobile application which may be facilitated by the mobile wallet provider (e.g., via the mobile wallet provider system 150), via text message, or via telephone call. During the communication between the mobile wallet user and the approver, the approver may question the mobile wallet user regarding the details of the transaction. For example, the approver may ask the mobile wallet user to provide justification for the purchase, or the approver may suggest an alternative purchase. In some embodiments, this communication is optional, as the approver may choose to approve or deny the transaction without further input from the mobile wallet user. In some embodiments, communication between the mobile wallet user (e.g., mobile device 160) and the approver (e.g., approver system 130) is facilitated by provider system 150. In one embodiment, the approver system may examine the approval request based on the rules stored in the approver system and rejects it if the request does not meet the rules or approves it if the request meet the rules without presenting it to the user of approver system. In other words, the approver systems 130 determines an approval or a rejection without communicating with the mobile wallet 120.

Block 424 includes the approver of approver system 130 approving the request and approver system 130 transmitting the approval. This approval is received by provider system 150 in block 426. In various embodiments, the approver may send the approval enable use of the mobile wallet account by the mobile wallet user via electronic means. For example, the approver (e.g., via approver system 130) may click on an approval button in a mobile application, or send an approval phrase or code to provider system 150 via text message. In alternative embodiments, the approver may verbally provide approval via telephone call.

Block 428 includes provider system 150 authorizing the payment based on the approval. In some embodiments, provider system 150 may be a banking entity associated with the source account that funds the mobile wallet. In these embodiments, provider system 150 may transmit funds to a merchant account (e.g., to merchant system 110, to an acquiring financial institution). In other embodiments, provider system 150 may authorize the payment by activating the payment credential for use by merchant system 110 to request payment. In other embodiments, provider system 150 provides source account information to merchant system 110. The source account information may be determined based on the payment credential. The authorization, and any associated information, is received by merchant computer system 110 in block 430.

Process 400 concludes with blocks 432 and 434. Block 432 includes merchant computer system 110 transmitting a message that the request for payment has been approved and the transaction has been completed. This message is received by mobile wallet circuit 120 in block 434. In some embodiments, merchant computer system 110 sends a receipt electronically to a mobile wallet account associated with mobile wallet circuit 120. For example, such a receipt may be stored in a receipt history in the mobile wallet application of the user's mobile device 160. Past receipts from the receipts history may be retrieved and displayed to the mobile wallet user. The mobile wallet user may also search the receipts for transactions relating to specific products, specific merchants, or specific locations of transactions. In various embodiments, the electronic receipt may also be sent to the approver. For example, the electronic receipt may be sent to an application installed on the approver's mobile device (e.g., approver system 130), and the approver may view the receipt history in the same manner as the mobile wallet user. If multiple mobile wallet accounts are associated with the same source account, the approver may review the receipt history of transactions from all associated mobile wallet accounts.

The receipt of the payment transaction may be transmitted to the mobile wallet user using various other means. For example, merchant computer system 110 may provide the mobile wallet user with a paper receipt as evidence of the completed transaction. In other embodiments, receipts may be emailed in electronic format to the email address(es) of the mobile wallet user and/or the approver, or sent via text message.

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may be embodied solely as machine-readable media for configuring hardware to execute the functions described therein. In yet other embodiments, the “circuit” may include a combination of machine-readable media and hardware components. As such, the “circuit” may include any type of component for accomplishing or facilitating achievement of the operations described herein.

When implemented with hardware components, the circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. Additionally, the “circuit” may include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In some embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

1. A payment processing system comprising a provider system, the payment processing system comprising:
one or more processors coupled to non-transitory memory, wherein the non-transitory memory stores instructions executable by the one or more processors and cause the one or more processors to:
receive a message, the message requesting payment from an account selected from a plurality of accounts, the account accessible via a mobile application on a first computing device of the user and funded by a separate source account;
determine a likelihood that the message requesting payment is fraudulent by assessing the message relative to a user-provided setting associated with the account;
responsive to determining that the message requesting payment is likely fraudulent, determine, at least one approval requirement by comparing a rule associated with the account to (i) a category associated with the payment and (ii) an amount of the payment;
provide, to a second computing device associated with an approver associated with the account, an approval request in accordance with the at least one approval requirement, wherein the approval request includes a predefined approval time limit and is provided in accordance with the rule associated with the account, wherein the approval request is provided via a first communication protocol when the amount is below a threshold amount and via a second communication protocol when the amount is equal to or above the threshold amount, wherein the first communication protocol is a push notification and the second communication protocol is a phone call;
initiate, based on the message, communications between the user and an approver associated with the account, the approver having authority to approve the payment, comprising the operations of:
causing a first executable associated with the mobile application to execute on the first computing device within the mobile application running on the first computing device and to initiate an electronic chat session between the user and the approver;
causing a second executable structured to execute on the second computing device to start, on the second computing device, a browser-based electronic chat session, wherein the approver does not need an approver account to approve transactions via the browser-based electronic chat session, the browser-based electronic chat session comprising a prompt for the approver to approve the payment; and
causing at least one electronic message to be initiated by one of the user and the approver via the browser-based electronic chat session comprising transmitting the at least one electronic message between the first computing device and the second computing device;
receive, based on information received via the browser based electronic chat session, an approval from the second computing device to complete the payment, wherein the approval is received via an electronic communication in accordance with the rule associated with the account;
determine, based on the received approval, that the approval is received within the predefined approval time limit; and
responsive to determining the approval is received within the predefined approval time limit, authorize use of the account by the first computing device to complete the payment.

2. The payment processing system of claim 1, wherein the message is received from at least one of the first computing device associated with the user and a computing device associated with a merchant.

3. The payment processing system of claim 2, wherein the one or more processors are further caused to implement the mobile application on at least one of the first computing device associated with the user and the second computing device associated with the approver.

4. The payment processing system of claim 3, wherein initiating communications between the user and the approver includes transmitting a first communication prompt to the first computing device or the second computing device associated with the approver.

4. The payment processing system of claim 4, wherein the first communication prompt is viewable by the approver via the mobile application implemented on the second computing device associated with the approver, and wherein the one or more processors are further caused to:
receive information concerning an interaction of the approver with the mobile application, the interaction of the approver including information input into the transmitted first communication prompt by the approver;
transmit, based on the interaction of the approver, a second communication prompt to the first computing device;
receive information concerning an interaction of the user with the mobile application, the interaction of the user including information input into the transmitted second communication prompt by the user; and
transmit, based on the interaction of the user, a third communication prompt to the second computing device associated with the approver.

6. The payment processing system of claim 5, wherein the third communication prompt includes a request for the approver to approve the payment requested in the message.

7. The payment processing system of claim 1, wherein the message includes at least one of:
an amount required to complete the payment;
goods to be purchased with the payment;
services to be purchased with the payment;
an identity of a merchant to receive the payment; and
a location of the merchant to receive the payment.

8. (canceled)

9. The payment processing system of claim 2, wherein the one or more processors are further configured to transfer funds to an account of the merchant to complete the payment.

10. The payment processing system of claim 1, wherein the approver is a parent and the user is a child of the parent.

11. The payment processing system of claim 1, wherein the approver is an employer and the user is an employee of the employer.

12. A computer-implemented method comprising:
receiving, by a processor of a payment processing system comprising a provider system, a message, the message requesting payment from an account selected from a plurality of accounts, the account accessible via a mobile application on a first computing device of the user;
determining, by the processor, a likelihood that the message requesting payment is fraudulent by assessing the message relative to a user-provided setting associated with the account;
responsive to determining that the message requesting payment is likely fraudulent, determining, by the processor, at least one approval requirement by comparing a rule associated with the account to (i) a category associated with the payment and (ii) an amount of the payment;
providing, to a second computing device associated with an approver associated with the account, an approval request in accordance with the at least one approval requirement, wherein the approval request includes a predefined approval time limit and is provided in accordance with the rule associated with the account, wherein the approval request is provided via a first communication protocol when the amount is below a threshold amount and via a second communication protocol when the amount is equal to or above the threshold amount, wherein the first communication protocol is a push notification and the second communication protocol is a phone call;
initiating, by the processor, based on the message, communications between the user and an approver associated with the account, the approver having authority to approve the payment, comprising the operations of:
causing, by the provider system communicatively coupled to each of the first computing device associated with the user and a second computing device associated with the approver, a first executable associated with the mobile application to execute on the first computing device within the mobile application running on the first computing device and to initiate an electronic chat session between the user and the approver;
causing, by the provider system, a second executable structured to execute on the second computing device to start, on the second computing device, a browser-based electronic chat session, wherein the approver does not need an approver account to approve transactions via the browser-based electronic chat session, the browser-based electronic chat session comprising a prompt for the approver to approve the payment; and
causing, by the provider system, at least one electronic message to be initiated by one of the user and the approver via the browser-based electronic chat session comprising transmitting the at least one electronic message between the first computing device and the second computing device;
receiving, by the processor and based on information received via the browser based electronic chat session, an approval from the second computing device to complete the payment, wherein the approval is received via an electronic communication in accordance with the rule associated with the account;
determining, by the processor and based on the received approval, that the approval is received within the predefined approval time limit; and
responsive to determining the approval is received within the predefined approval time limit, authorizing use of the account by the first computing device to complete the payment.

13. The computer-implemented method of claim 12, wherein the message is received from at least one of the first computing device associated with the user and a computing device associated with a merchant.

14. The computer-implemented method of claim 13, further comprising implementing, by the processor, the mobile application on at least one of the first computing device associated with the user and the second computing device associated with the approver.

15. The computer-implemented method of claim 14, wherein initiating communications between the user and the approver includes transmitting, by the processor, a first communication prompt to the first computing device or the second computing device.

16. The computer-implemented method of claim 15, wherein the first communication prompt is viewable by the approver via the mobile application implemented on the second computing device associated with the approver, and the method further comprises:
receiving, by the processor, information concerning an interaction of the approver with the mobile application, the interaction of the approver including information input into the transmitted first communication prompt by the approver;
transmitting, by the processor, based on the interaction of the approver, a second communication prompt to the first computing device;
receiving, by the processor, information concerning an interaction of the user with the mobile application, the interaction of the user including information input into the transmitted second communication prompt by the user; and
transmit, based on the interaction of the user, a third communication prompt to the second computing device associated with the approver, the third communication prompt including a request for an approval of the requested payment in the message.

17. The computer-implemented method of claim 16, wherein authorizing includes transferring funds to the merchant to complete the payment.

18. A computer-implemented method comprising:
receiving, by a processor of a payment processing system comprising a provider system, a message, the message requesting payment from an account selected from a plurality of accounts, the account accessible via a mobile application on a first computing device of the user and funded by a separate source account;
determining, by the processor, a likelihood that the message requesting payment is fraudulent by assessing the message relative to a user-provided setting associated with the account;
responsive to determining that the message requesting payment is likely fraudulent, determining, by the processor, at least one approval requirement by comparing a rule associated with the account to (i) a category associated with the payment and (ii) an amount of the payment;
providing, to a second computing device associated with an approver associated with the account, an approval request in accordance with the at least one approval requirement, wherein the approval request includes a predefined approval time limit and is provided in accordance with the rule associated with the account, wherein the approval request is provided via a first communication protocol when the amount is below a threshold amount and via a second communication protocol when the amount is equal to or above the threshold amount, wherein the first communication protocol is a push notification and the second communication protocol is a phone call;
initiating, by the processor, responsive to determining that the message requires approval, communications between the user and the approver, comprising the operations of:
causing a first executable associated with the mobile application to execute on the first computing device within the mobile application running on the first computing device and to initiate an electronic chat session between the user and the approver;
causing, by the provider system, a second executable structured to execute on the second computing device to start, on the second computing device, a browser-based electronic chat session, wherein the approver does not need an approver account to approve transactions via the browser-based electronic chat session, the browser-based electronic chat session comprising a prompt for the approver to approve the payment; and
causing, by the provider system, at least one electronic message to be initiated by one of the user and the approver via the browser-based electronic chat session comprising transmitting the at least one electronic message between the first computing device and the second computing device;
receiving, by the processor and based on information received via the browser based electronic chat session, an approval from the second computing device to complete the payment, wherein the approval is received via an electronic communication in accordance with the rule associated with the account;
determining, by the processor and based on the received approval, that the approval is received within the predefined approval time limit; and
responsive to determining the approval is received within the predefined approval time limit, authorizing use of the account by the first computing device to complete the payment.

19. The computer-implemented method of claim 18, wherein the message is received from at least one of the first computing device associated with the user and a computing device associated with a merchant, the method further comprising implementing, by the processor, the mobile application on at least one of the first computing device associated with the user and the second computing device associated with the approver.

20. The computer-implemented method of claim 19, wherein the first communication prompt is viewable by the approver via the mobile application implemented on the second computing device associated with the approver, and the method further comprises:
receiving, by the processor, information concerning an interaction of the approver with the mobile application, the interaction of the approver including information input into the transmitted first communication prompt by the approver;
transmitting, by the processor, based on the interaction of the approver, a second communication prompt to the mobile device;
receiving, by the processor, information concerning an interaction of the user with the mobile application, the interaction of the user including information input into the transmitted second communication prompt by the user; and
transmitting, based on the interaction of the user, a third communication prompt to the computing device associated with the approver, the third communication prompt including a request for an approval of the requested payment in the message.
